(19) United States
(12) Patent Application Publication
(10) Pub. No.: US 2012/0150496 A1
(43) Pub. Date: Jun. 14, 2012

(54) Simplified Fast 3D Finite Difference Particulate Flow Algorithms for Liquid Toner Mobility Simulations

(76) Inventor: Jiun-Der Yu, Sunnyvale, CA (US)

(21) Appl. No.: 12/964,257

(22) Filed: Dec. 9, 2010

(51) Int. Cl. G06F 17/10

(52) U.S. Cl. 703/2

(57) ABSTRACT

In updating particle information in a particulate fluid flow simulation, a 2D/3D collision scheme checks for the existence of any particle collision, and if so, calculates the collision force and torque on each colliding particle. Another 2D/3D collision scheme checks whether any particle is contacting a solid wall domain boundary, and if so, calculates the wall force and torque. Following collision, the particle location is updated according to the particle translational velocity, the collision force, and the domain wall reaction force. The particle orientation is updated according to the particle angular velocity, collision torque, and wall reaction torque.

### CROSS-REFERENCE TO RELATED APPLICATION(S)

The present application is related to (i) U.S. patent application Ser. No. 12/707,956, filed on Feb. 18, 2010, entitled “A Finite Difference Particulate Fluid Flow Algorithm Based on Level Set Projection Framework,” and (ii) U.S. patent application Ser. No. 12/878,784 filed on Sep. 9, 2010, entitled “Collision Effect and Particle Information Update in Particulate Fluid Flow Simulations,” each of which is incorporated by reference herein in its entirety.

### BACKGROUND

1. Field of Invention

The present invention is directed toward systems and methods for simulating two- and three-dimensional (2D and 3D) particulate fluid flows.

2. Description of Related Art

Particulate fluid flows are of great interest and of fundamental importance. Liquid toner, electrophoresis, and colloidal flows are just a few examples of particulate fluid flows. An easy model for particulate fluid flow consists of rigid solid particles and Newtonian fluid. To simulate particulate fluid flows with rigid solid particles, it is preferable to have an algorithm that solves the nonlinear Navier-Stokes equations and the particle effect at the same time.

Prior art methods for simulating particulate fluid flows include using the Navier-Stokes equations, which treat the particles as fluid with an additional constraint on the rigidity of the particles. An example of this method is illustrated in Nitin Sharma et al., A Fast Computation Technique for the Direct Numerical Simulation of Rigid Particulate Flows, Journal of Computational Physics, 205(2):439-457, May 20, 2005 (Sharma). Sharma's method is based upon a volume of fraction function approach to represent the particle-fluid boundary. A consequence of the Sharma method is that the numerical “thickness” of the interface is one cell.

The cross-referenced applications identified above provide improvements on Sharma's technique as described in such applications.

### SUMMARY OF INVENTION

The present disclosure provides still further improvements in particulate fluid flow analysis, including simplified 3D collision schemes.

When a particle collision occurs, one has to detect the particles that collide, and, if needed, implement the forces incurred by the collision. In cases with high viscosity fluid, which are of particular interest, the effect of lubrication is strong. That is to say whether the collision among particles is fully elastic, non-elastic, or somewhere in between is relatively unimportant. That there be no overlapping of particles, however, is important. Hence, a goal of the collision scheme is to first check, preferably at the end of each time step, whether a pair or group of particles are colliding, and if so, to find the contact point(s) or overlapping area(s) and to define a suitable force and torque to repel these particles so that they do not overlap. Because the time step is usually small in a highly viscous fluid flow simulation, the overlap among particles, if it exists, is also very small. This greatly facilitates the design of a collision scheme.

In the present invention, the incompressible Navier-Stokes equations are still first solved everywhere in the solution domain, including the region occupied by the rigid solid particles. The obtained velocity is rendered incompressible everywhere in the solution domain by enforcing the continuity equation (i.e., by doing projection). The incompressible velocity field in the regions occupied by the particles is further corrected so that it represents rigid body motion. A simplified 2D/3D collision scheme is developed and employed to check whether any particle collision occurs, and if so, the collision force and torque on each colliding particle are calculated. Another 2D/3D collision scheme is developed and employed to check whether any particle is hitting the solution domain boundary, and if so, and if the domain boundary is a solid wall, the wall force and torque are calculated. Finally, the particle location is updated according to the particle translational velocity, the collision force, and the domain wall reaction force. The particle orientation is updated according to the particle angular velocity, collision torque, and wall reaction torque. The 2D and 3D simulation codes based on the present invention run much faster than known prior simulation codes.

One aspect of the invention comprises a non-transitory medium encoded with a program for execution by one or more processors to determine particle information in a particulate fluid flow. The program comprises instructions for determining whether two particles can be in contact based on the location of the center of a second of the two particles with respect to an envelop of the first of the two particles; instructions for determining more precisely whether the first and second particles are in contact, including instructions for dissecting the perimeter of the second particle into a plurality of patches defining a plurality of nodes and checking whether each node is located in the envelop, and which node is most inside the envelop, determining the contact point on the second particle based on the results of executing the dissecting instructions, and determining the contact point on the first particle. Instructions also provided for calculating a force and torque on the particles from the fluid; and determining, based at least in part on the calculated force and torque on the particles, updated velocity components, position, and orientation of at least one of the particles.

Preferably, the instructions for determining the contact point on the first particle comprise instructions for representing the surface of the first particle by a multiple parameter equation and solving for the multiple parameters in a local coordinate system of the first particle.

In another aspect, the invention entails a non-transitory medium with a program for execution by one or more processors to determine particle information in a particulate fluid flow in a solution domain. The program comprises instructions for finding an external bounding box for a particle in the particulate fluid flow; instructions for determining whether the particle is in contact with a boundary of the solution domain; and instructions for constructing a wall force and torque on the particle using the external bounding box.

In some embodiments, the boundary includes a vertical wall and a horizontal wall, and the instructions for determining comprise instructions for determining whether a particle is in contact with the vertical wall and instructions for determining whether the particle is in contact with the horizontal wall.

The program preferably further includes instructions for calculating the moment of inertia tensor for each particle in the particulate fluid flow.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts.

FIG. 1 shows the locations of discrete variables in connection with a spatial algorithm described herein.

FIG. 2 is a flow chart illustrating 2D collision schemes for elliptic particles.

FIG. 3 shows two ellipses of different orientations and sizes in connection with 2D collision schemes for elliptic particles.

FIG. 4 shows two ellipsoids of different orientations and sizes in connection with 3D collision schemes for ellipsoidal particles.

FIG. 5 shows the orientation of a local coordinate system axis of a particle with respect to the fixed global coordinate system in connection with 3D collision schemes for ellipsoidal particles.

FIG. 6 is an illustration of a system in which embodiments of the present invention may be practiced.

### DESCRIPTION OF THE PREFERRED EMBODIMENTS

### I. Governing Equations

Consider a particulate fluid flow system with a few rigid, electrically charged solid particles in a viscous fluid. The fluid is Newtonian and incompressible with density ρ_{f}, dynamic viscosity μ, and dielectric permittivity ∈₀∈_{f}. The solid particles are rigid with density ρₛ, dielectric permittivity ∈₀∈ₛ, and charge density q. Let Ω denote the solution domain which includes the solid particles and the fluid. Let P(t) be the part of Ω that is occupied by the solid particles and ∂P be the fluid particle interface. The governing equations include the Gauss equation of charge, the Navier-Stokes equation, the continuity equation, and the rigid body constraint, presented as equations (1), (2), (3), and (4), respectively, in the Appendix to the specification. Other equations numerically-referenced below are also set forth in the Appendix. In the Gauss equation of charge, ∈₀ is the dielectric permittivity of vacuum, ∈ the relative dielectric constant of the oil or particle, φ the electric potential, and q the electric charge density. In the Navier-Stokes equations, u is the fluid velocity, ρ is the density, μ is the dynamic viscosity of the fluid, and E=−∇φ is the electric field. It is noted that, since the solution domain consists of the fluid and the solid particles, the dielectric permittivity, charge density, and mass density are functions of the space variable given by equations (5). For the case where the fluid is not charged, as is the case in the illustrated embodiments, q_{f}=0.

The boundary conditions at the interface of the fluid and the particles are the continuity of the velocity, the continuity of the traction force, the continuity of the normal component of the electric displacement D=∈E , and the continuity of the tangential components of the electric field E. However, they are automatically satisfied because the equation of motion of the solid particles has been merged into the Navier-Stokes equations (so the density takes different values in the fluid and solid particle sub-domains), and the same fluid dynamic viscosity has been used everywhere (including the part occupied by the particles). There are boundary conditions to satisfy at the boundary of the domain Ω. On solid walls, it is assumed that the normal and tangential components of the velocity vanish. At both inflow and outflow, the present formulation allows prescription of either the velocity given by equation (6) or the pressure boundary condition given by equations (7), where n denotes the unit normal to the inflow or outflow boundary. For the Gauss equation, either the boundary potential given by equation (8) is prescribed or the Newmann condition defined in equation (9) is assumed, where n is the unit normal to the boundary.

There are at least two ways to make the governing dimensionless, which are discussed in the next two subsections.

1. Normalization I

One way of normalization is to use the convection time scale, according to equations (10), where the primed quantities are dimensionless and L, U, ρ_{f}, V₀ are respectively the characteristic length, characteristic velocity, density of the fluid, and the externally applied voltage. Substituting the equations (10) into equations (2)-(4), and dropping the primes, yields equations (11)-(14), where the density ratio ρ, Reynolds number, dimensionless charge density σ, and dimensionless electrostatic force are defined by equations (15).

This format of governing equations is best for simulation cases in which the Reynolds number is large. One can see that, when the Reynolds number is very large (Re>>1), the viscosity term is relatively unimportant and can be neglected in simulations. Equation (12) without the viscosity term is usually referred to as Euler's equation.

2. Normalization II

Another way of normalization is to use the viscosity time scale, according to equations (16), where the primed quantities are dimensionless and L, U, ρ_{f}, V₀ are respectively the characteristic length, characteristic velocity, density of the fluid, and the externally applied voltage. Substituting the equations (16) into equations (2)-(4), and dropping the primes, yields equations (17)-(20), where the density ratio ρ, Reynolds number, dimensionless charge density σ, and dimensionless electrostatic force are defined by equations (21).

This second way of normalization is more suitable for simulations with a small Reynolds number, which is the case for liquid toner applications. One can see that, if the Reynolds number is much less than 1, the convection term is relatively unimportant and can be neglected in simulations. Equation (18) without the convection term is often referred to as the creeping flow equation.

### II. Basic Numerical Algorithms

Initially, it is noted that the superscript n (or n+1) denotes the time step, as in equation (22) and so on. The algorithms described herein are based on a particulate fluid flow algorithm called distributed Lagrangian multiplier method (DLM) first developed by Sharma. The algorithm works well for both 2D and 3D problems, whether there are single or multiple particles.

1. Temporal Algorithm

Suppose we have velocity uⁿ, pressure pⁿ, particle center of mass location x_{c}ⁿ=(x_{c}ⁿ, y_{c}ⁿ, z_{c}ⁿ), linear velocity mass center of the solid particle Uⁿ, and angular velocity Ωⁿ, the purpose of the temporal algorithm is to integrate the governing equations in time to obtain uⁿ⁺¹, pⁿ⁺¹, x_{c}ⁿ⁺¹, Uⁿ⁺¹, Ωⁿ⁺¹. The algorithm described herein is first-order accurate in both time and space.

1.1 Calculate the Material Property Distributions

Several material property distributions need to be calculated before any of the equations can be integrated to obtain field variables at tⁿ⁺¹ These include the density distribution ρⁿ, the dielectric permittivity distribution ∈ⁿ, and the charge distribution qⁿ. They are obtained using the particle locations x_{c}ⁿ at tⁿ.

1.2 Solve the Gauss Equation of Charge

The Gauss equation of charge is solved using the Multigrid (MGD) method. The electric potential φⁿ is obtained and, hence, the electric field Eⁿ.

1.3 Obtain the Electrostatic Force Distribution

The electrostatic force distribution fₑⁿ is calculated by simply taking the product qⁿ×Eⁿ and doing the normalization in equations (15) or (21).

1.4 Time Integration for Momentum and Continuity Equations

When the Reynolds number is greater than 1, usually an explicit integration scheme (which is easier to implement) works well for the simulation. However, if the Reynolds number is less than 1, a semi-implicit time integration scheme may be needed for the momentum and continuity equations. Both the explicit and semi-implicit time integration schemes are explained here.

A. Explicit Time Integration

Since the explicit time integration works well when the Reynolds number is not small (Re>1), equations from “Normalization I” are used to explain the explicit scheme. For an explicit temporal algorithm, first calculate equation (23). Then solve projection (Poisson's) equation (24) to obtain the new pressure. Finally, the velocity predictor û at tⁿ⁺¹ is obtained by equation (25).

In equation (23), one can basically apply any explicit advection scheme (1^{st}- 2^{nd}- or even higher-order) for the advection term. For better stability performance, the 1^{st}-order upwind scheme for the advection term is used. It is noted that the Godunov method for advection term is not compatible with the DLM scheme for particulate fluid flows; hence, it is recommended not to use any versions of the Godunov method. The central difference for the viscosity term is used. It is also noted that the right hand side of equation (23) consists of only known quantities from time step n. Hence, it is very easy to calculate u*. For equation (24), the Multigrid method (MGD) is employed to solve the resulting linear system.

B. Semi-Implicit Time Integration

Since the semi-implicit time integration is necessary when the Reynolds number is small, equations from “Normalization II” are used to explain the semi-implicit scheme. For temporal integration, first calculate equation (26). It is noted that in contrast to the explicit scheme, the pressure gradient is included in the right hand side of equation (26) to improve the accuracy of the velocity predictor when a bigger time step is used. Since the desire is to project the whole velocity predictor to obtain the whole new pressure, the pressure gradient is subtracted to obtain the first velocity predictor, given by equation (27). Then solve projection (Poisson's) equation (28) to obtain the new pressure. Finally, the velocity predictor û at tⁿ⁺¹ is obtained by equation (29).

In equation (26), one can again use the 1^{st}-order upwind scheme for the advection term and the central difference for the viscosity term. It is noted that one needs to solve a linear system to obtain u** from equation (26), since it shows up in both the right and left hand sides of the equation. The linear system is well conditioned as long as the time step Δt is only a few times larger than the CFL number of the explicit scheme. The successive-over-relation method (SOR) should work well in solving the linear system when Δt is not too large. However, if the time step is several orders larger than the CFL, a multigrid method is necessary to guarantee the fast convergence when solving the resulting linear system. Since the viscosity term at the right hand side of equation (26) is defined using unknown velocity u**, the time integration scheme is implicit for the viscosity term. However, because the convection term and the projection step is still explicit, the time integration scheme is only “semi-implicit.”

1.5 Rigid Body Projection

The explicit time integration of momentum and continuity equations is done without considering whether there is a solid particle or not. So, the obtained velocity û is actually the fluid velocity at tⁿ⁺¹ in the fluid region Ω/P(t). Sharma argues that the linear and angular momenta of the particle region should be conserved during the rigid body projection. In that respect, the present algorithm follows Sharma's procedure. The linear and angular momenta of the particle region are first calculated. Moreover, because they should be conserved, the new mass center linear velocity and the new angular velocity of the solid particle can be obtained using equations (30) and (31) respectively, where M is the mass of the solid particle, Iₚ is the moment of inertia tensor of the solid particle, x_{c}ⁿ is the location of the center of mass of the solid particle at t=tⁿ, Uⁿ⁺¹ is the mass center translational velocity of the particle at t=tⁿ⁺¹, and Ωⁿ⁺¹ is the new angular velocity of the particle. The calculation of Iₚ will be explained below. In 2D, Iₚ will reduce to a scalar.

After the new mass center velocity and angular velocity are obtained, the velocity in the particle region is updated by equation (32).

1.6 Particle Location and Orientation Update

The next step is to update the particle center of mass location using equation (33). If the particle is not spherical (in 3D) or not circular (in 2D), one also has to update the orientation of the particle by using the angular velocity Ω. For example, suppose e₁^{j} is a unit vector in the direction of the longest axis of ellipsoidal particle j. The orientation of the unit vector with respect to the fixed global coordinate system can be represented by the three direction cosines l_{1′α}=e₁^{j}·e_{α}, α=1, 3 between e₁^{j} and the three fixed axes. The new orientation of the longest axis can be obtained by using equation (34), where e_{αβγ} is the unit alternating tensor. The other two axis orientations can be updated in a similar way.

1.7 Particle and Domain Wall Collision Effects

Calculate the linear and angular acceleration caused by particle and domain wall collisions for each particle using equations (35), where F^{C}, T^{C}, F^{w}, and T^{w} are respectively the forces and torques resulting from particle collisions and domain wall collisions. The particle location and orientation are then updated by equations (36) and (37).

1.8 Normalize the Orientation Vectors of Each Particle

Each of the orientation vectors (l_{i′1}, l_{i′2}, l_{i′3}), i=1, 2, 3 is originally a unit vector. However, after the finite rotations in equations (34) and (38), they will not remain so. For the stability and accuracy of simulation, one needs to normalize the three orientation vectors at the end of each time step so that they remain as unit vectors.

2. Constraints on Time Step

2.1 Explicit Scheme

If the explicit time integration scheme is used, the time step Δt will be constrained in the CFL condition (due to convection, viscosity, and total acceleration), as provided in equation (38), where h=min(Δx,Δy,Δz) and the force variable is given by equation (39).

2.2 Semi-Implicit Scheme

If the semi-implicit time integration scheme is used, the time step can be much larger, as provided by equation (40), where h=min(Δx,Δy,Δz) and the force variable is given by equation (41).

3. Spatial Algorithm

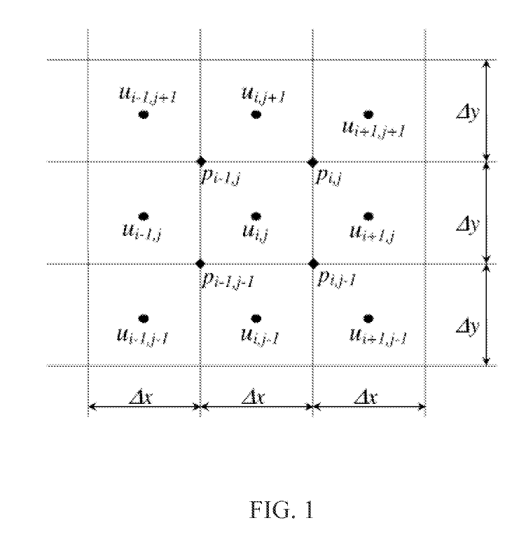

FIG. 1 shows the locations of discrete variables. The velocity components, electric potential, and electric field components are located at cell centers, while the pressure is located at grid points. The material properties like mass density, dielectric permittivity, and dynamic viscosity are also evaluated at the center of the each cell.

3.1 Advection term

The advection term in equations (23) and (24) is evaluated using the 1^{st}-order upwind scheme, as per equation (42).

3.2 Viscosity Term

The viscosity term in equations (23) and (24) is evaluated using the central differencing of equation (43).

3.3 LHS of Gauss Equation

The LHS of the Gauss equation is discretized using the same central difference technique as provided by equations (44) and (45).

3.4 Calculation of Electric Field

After the electric potential is solved from the Gauss equation of charge, the electric field can obtained by central differencing according to equations (46).

### III. Collision Schemes

For a particulate fluid flow system with multiple solid particles, the linear momentum and angular momentum are evaluated for each particle in the rigid particle projection step. When particle collisions occur, one has to detect the particles that collide and, if needed, implement the forces and torques incurred by collision. In cases with high viscosity fluid, which are of particular interest, the effect of lubrication is strong. That is to say whether the collision among particles is fully elastic, non-elastic, or somewhere in between is relatively unimportant. That there be no overlapping of particles, however, is important. Hence, a goal of the collision scheme is to first check, at the end of each time step, whether a pair or a group of particles are colliding, and if so, to find the contact points or overlapping area and to define a suitable force and torque to repel these particles so that they do not overlap. Because the time step is usually small in a highly viscous fluid flow simulation, the overlap among particles, if it exists, is also very small. This greatly facilitates the design of a collision scheme. The most common shape encountered in connection with the work pertaining to the present disclosure is the ellipse for 2D and the ellipsoid in 3D. The following describes two collision schemes for 2D elliptic particles and one collision scheme for 3D ellipsoidal particles. A circular/spherical particle can be deemed a special case of the elliptic/ellipsoidal particle.

1. 2D Scheme for Elliptic Particles

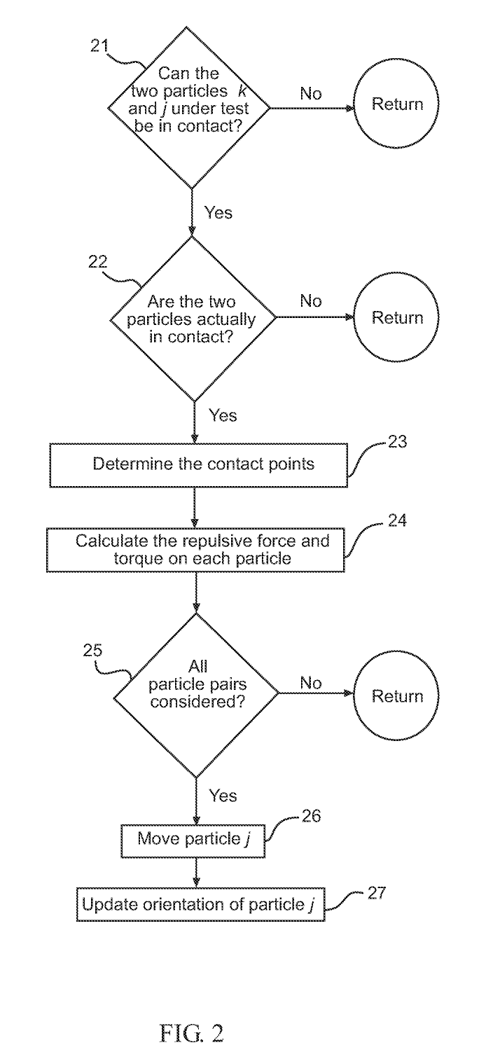

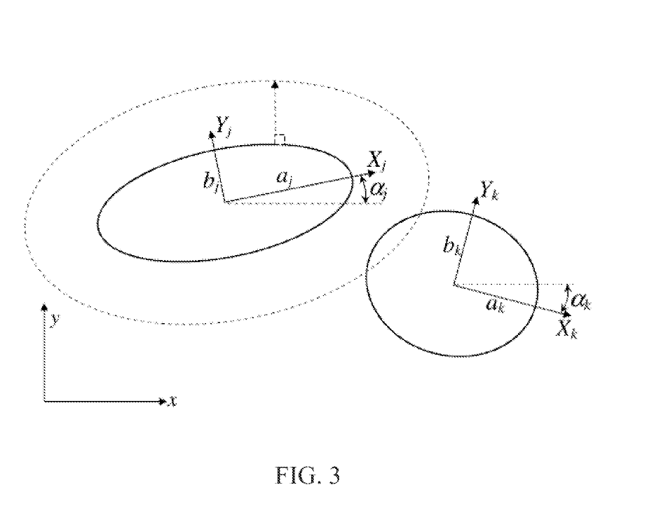

This scheme is described with reference to the flow chart of FIG. 2. The first step is to check whether two particles can be in contact or not (step 21). As shown in FIG. 3, consider two elliptic particles, say particle j and particle k, of different sizes and orientations. Particle j's major axis is aⱼ and minor axis bⱼ, where aⱼ≧bⱼ. Its orientation, which is the angle between the major axis and the x axis of the fixed global coordinate system, is αⱼ. Particle k's major and minor axes and orientation are given by the same variables but with k as the subscript. The dashed curve in FIG. 3 is an envelop of ellipse j. The shortest distance of each point on the envelop to ellipse j is aₖ. The dashed curve is not an ellipse, and there is no mathematical formula to precisely describe it. However, in the local Xⱼ−Yⱼ coordinate system, we can approximate the dashed curve or envelop as another ellipse, whose equation is given by equation (47). If the center x_{c,k} of the second particle k is not located on or inside the dashed envelop, the two elliptic particles cannot be in contact with each other. It is noted that it is possible that the two ellipses are not in contact even if the center of the second particle is inside the dashed envelop. In a particulate flow system with quite a lot of particles, any particle most likely is only in contact with a few other particles. So, the purpose of the first step is just to quickly rule out the collision of most particles. Hence, first calculate the relative location of the center of particle k with respect to the local coordinate system of particle j according to equations (48). Then calculate equation (49). If D_{k,j}≦0, the center of particle k is outside the dashed envelop of particle j and the two particles are deemed to not be in contact. If D_{k,j}<0, the two particles can be in contact.

If the two particles under test (j and k) cannot be in contact, the routine considers whether another pair of particles can be in contact.

If it is determined in the first step that the two elliptic particles in consideration can be in contact, the next step is to check precisely whether they are in fact in contact (step 22). To do this, the perimeter of the second elliptic particle (particle k) is dissected into m arcs (so there are m nodes). The number m should be large enough so that each arc can be accurately approximated as a straight segment, but should not be so large to require an unreasonably large amount of calculation (CPU) time. In the work done in connection with this disclosure 60≦m≦100. For each of m nodes, check whether it is located in the first ellipse. To do this, first calculate the coordinates of the i^{th} (1≦i≦m) node with respect to the local coordinate system of particle k given by equations (50). The relative location with respect to the local coordinate system of particle j is then calculated according to equations (51). Next, it is checked whether (x_{k,j}ⁱ, y_{k,j}ⁱ) is located in the first elliptic particle (particle j) by calculating equation (52). If D_{k,j}ⁱ>0 for all 1≦i≦m, the two ellipses are not in contact. The process then returns to step 21 to consider another pair of particles, if any. If D_{k,j}ⁱ≦0 for any 1≦i≦m, then the two ellipses are in contact.

In step 23, the contact points are determined. Take the node that lies most inside the particle j (i.e., the node that gives the minimal D_{k,j}ⁱ) as the contact point (x_{cont,k}^{k}, y_{cont,k}^{k}) on particle k, referred to as the local coordinates on particle k. The contact point is denoted by (x_{cont,k}, y_{cont,k}) when referred to the fixed global coordinates.

Having determined the contact point on particle k, next locate the contact point on the first particle (particle j). This can be done in a way similar to the previous step, i.e., by dissecting the perimeter of particle j into m arcs (with m nodes) and checking which node lies most inside the second particle (particle k). So, first calculate the coordinates of the i^{th} (1≦i≦m) node with respect to the local coordinate system of particle j, according to equations (53). Its relative location with respect to the local coordinate system of particle k is then calculated according to equations (54), with the relative center location defined as in equations (55). Next it is checked whether (x_{j,k}ⁱ, y_{j,k}ⁱ) is located in the second elliptic particle (particle k) by calculating equation (56). Take the node that lies most inside the particle k (i.e., the node that gives the minimal D_{j,k}ⁱ) as the contact point (x_{cont,j}, y_{cont,j}) on particle j.

Next, in step 24, the repulsive force and torque on the first particle (particle j) and on the second particle (particle k) is calculated as per equations (57) and (58), respectively, where A is a force amplitude that is large enough to keep particles apart. In the work of the present disclosure, it has been learned that A should be one order larger than the resultant force on the particle.

All particle pairs should be evaluated to determine all collisions. If it is determined in step 25 that all particle pairs have not yet been considered, the routine returns to step 21 to begin again for another particle pair. After all the possible collisions have been considered, and all the repulsive forces and torques are calculated, the j^{th} particle is moved in step 26 as determined by equation (59), where x_{c,j}ⁿ⁺¹ and x_{c,j}ⁿ are the center of particle j at time tⁿ⁺¹ and tⁿ, respectively, Δt is the time step, Uⱼⁿ⁺¹ is the particle velocity as calculated according to U.S. patent application Ser. No. 12/707,956 identified above, Fⱼ^{C} is the total collision force on particle j (exerted by all the particles colliding with it), and Mⱼ is the total mass of particle j. Similarly, the orientation of the j^{th} particle is updated in step 27 using equation (60), where αⱼⁿ⁺¹ and αⱼⁿ are the orientation of particle j at time tⁿ⁺¹ and tⁿ, respectively, ωⱼⁿ⁺¹ is the angular velocity as calculated according to '956 application identified above, Tⱼ is the total collision torque on the particle j (exerted by all particles colliding with it), and Iⱼ is the moment of inertia of particle j.

2. 2D Alternative for Elliptic Particles

The collision scheme in the previous subsection works well. However, the perimeter dissecting of both particles consumes a lot of CPU time. An alternate approach is described in this subsection. This is described with reference to FIG. 2 as the general flow is the same, although the methodology and technique used to carry out some of the steps are different as described below.

Steps 21 and 22 of FIG. 2 are the same in this alternate approach. In determining the contact points, in step 23, take the node that lies most inside the particle j (i.e., the node that gives the minimal D_{k,j}ⁱ) as the contact point (x_{cont,k}^{k}, y_{cont,k}^{k}) on particle k. The same point is denoted as (x_{cont,k}, y_{cont,k}) when referred to the fixed global coordinate system; and is (x_{cont,k}^{j}, y_{cont,k}^{j}) when referred to the local system on particle j. Here, the perimeter of the first particle (i.e., particle j) is not dissected. Suppose the p^{th} node on particle k has been found located most inside particle j. Calculate the inward normal to particle k at the p^{th} node by (referring to the local coordinates on particle k) evaluating equations (61). Referring to the fixed global coordinate system, the inward normal to particle k is given by equation (62).

The next thing is to find the contact point on the first particle (particle j). Since the time step used in a particulate fluid flow code is usually very small (it is so small that any particle only moves a distance smaller than a fraction of the particle size), the contact point on the second particle (particle k) as calculated above is usually extremely close to the surface of the first particle (particle j). Since the surface of the first particle can be represented by (xⱼ, yⱼ)=(aⱼ cos θ, bⱼ sin θ), an approximation can be made by solving the corresponding parameters for the contact point in the local coordinate of particle j from equations (63). The solution is given by equations (64) and (65). The parameter ∈ is usually just slightly less than 1, which is saying that the contact point on particle k is very close to the surface of particle j. Hence, take the contact point on particle j to be (referred to the local coordinates on particle j) as given by equation (66). When referred to the global coordinate system, the contact point on particle j is given by equation (67).

In step 24, the collision forces on the two particles are determined according to equations (68), and the collision torques according to equations (69).

Steps 25-27 are the same in the alternative approach as in the first approach described.

3. 3D Scheme for Ellipsoidal Particles

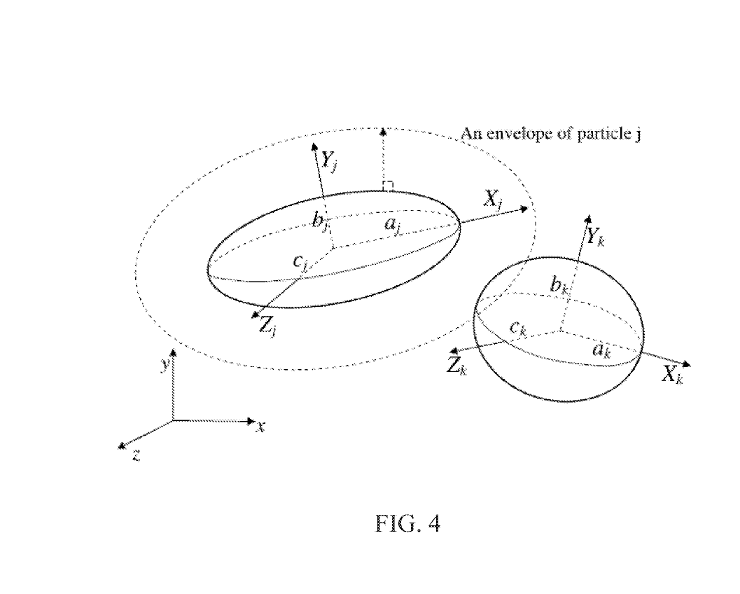

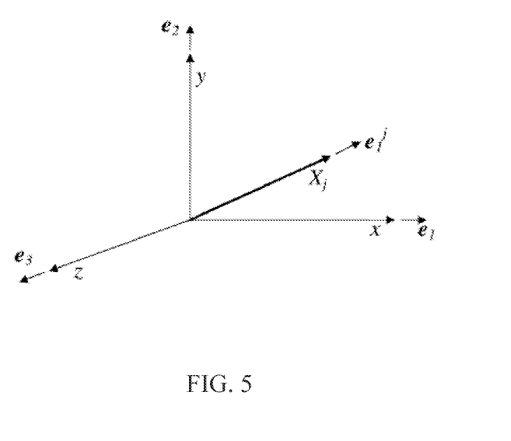

This scheme is also described with reference to FIG. 2, as the general flow is the same with the differences in step implementation being described herein. As is the case in the 2D schemes, the first step in the 3D scheme is to check whether two particles can be in contact or not (step 21). For purposes of description and illustration, two ellipsoidal particles are assumed—say particle j and particle k, of different sizes and orientations. FIG. 4 shows two such particles. Particle j's three axes are aⱼ, bⱼ, cⱼ in length, where aⱼ≧b₁≧cⱼ. Its orientation, which is represented as the direction cosines between the three axes and the global x, y, z axes, is l_{αβ}^{j} defined by equation (70), where e_{α}^{j} is the unit base vector along the α-th axis of the local coordinate system for particle j and e_{β} is the unit base vector along the β-th axis of the fixed global coordinate system. FIG. 5 shows the relative orientation of the first axis of particle j with respect to the fixed global coordinate system. Particle k's axes are aₖ, bₖ, cₖ and orientation is l_{αβ}^{k}. The dashed curve in FIG. 4 is an envelop of ellipsoid j. The shortest distance of each point on the envelop to ellipsoid j is aₖ. Theoretically, one cannot have any functional description of the envelop. However, in the local Xⱼ−Yⱼ−Zⱼ coordinate system, the envelop can be approximated as another ellipsoid, whose equation is given by equation (71). If the center x_{c,k} of the second particle k is not located on or inside the dashed envelop, the two elliptic particles most likely are not in contact with each other. It is noted that it is possible that the two ellipsoids are not in contact even if the center of the second particle is inside the dashed envelop or the two ellipsoids are in contact even if the center of the second particle is not inside the dashed envelop. In a particulate flow system with quite a lot of particles, any particle most likely is only in contact with a few other particles. So, the purpose of the first step is to quickly rule out the collision of most particles. Hence, first calculate the relative location of the center of particle k with respect to the local coordinate system of particle j according to equations (72). Then calculate equation (73). If D_{k,j}>0, the center of particle k is outside the dashed envelop of particle j, and the two particles are deemed to be not in contact. If D_{k,j}≦0, the two ellipsoidal particles can be in contact.

If the two particles under test (j and k) cannot be in contact, the routine considers whether another pair of particles can be in contact.

If it is determined in the first step that the two ellipsoidal particles in consideration can be in contact, the next step is to check precisely whether they are in fact in contact (step 22). To do this, the perimeter of the second particle (particle k) is dissected into m×n patches (and about a similar number of nodes). The numbers m and n should be large enough so that each patch is small enough that it can be considered as a flat plan, but should not be so large to require an unreasonably large amount of calculation (CPU) time. In the work done in connection with this disclosure 60≦m≦100 and n can be about half as large as m. For each of the nodes, check whether it is located in the first ellipsoid. To do this, first calculate the coordinates of a node on the perimeter of particle k with respect to the local coordinate system of particle k according to equations (74), where 1≦p≦m, 0≦q≦n, and other variables defined as in equations (75). The relative location with respect to the local coordinate system of particle j is then calculated according to equations (76), where equation (77) holds. Next, it is checked whether (x_{k,j}, y_{k,j}, z_{k,j}) is located in the first ellipsoidal particle (particle j) by calculating equation (78). If D_{k,j}>0 for all θₚ and φ_{q} the two ellipsoids are not in contact, and the routine returns to step 21 to consider another pair of particles, if any. If D_{k,j}≦0 for some θₚ and φ_{q}, then the two ellipsoids are in contact.

In step 23, the contact points are determined. To determine the contact point on particle j, take the node that lies most inside the particle j (i.e., the node that gives the minimal D_{k,j}) as the contact point. The contact point on particle k is denoted by (x_{cont,k}^{k}, y_{cont,k}^{k}, z_{cont,k}^{k}) when referred to the local coordinate system of particle k, by (x_{cont,k}, y_{cont,k}, z_{cont,k}) when referred to the global fixed coordinate system, and by (x_{cont,k}^{j}, y_{cont,k}^{j}, z_{cont,k}^{j}) when referred to the local coordinate system on particle j. The relationship between them is given by equations (79) and (80). The inward normal at the contact point (referred to the local coordinate system on particle k) is given by equation (81), where the first vector is a tangent vector to the contact point on ellipsoid k obtained taking the derivative of equation (74) with respect to the parameter θₚ, and the second is a tangent vector obtained by taking the derivative of equation (74) with respect to the parameter φ_{q}. nₖ^{k} is not a unit vector but can be made one by normalization according to equation (82). In the fixed global coordinate system, the inward normal is given by equation (83).

Having determined the contact point on particle k, next locate the contact point on the first particle (particle j) and calculate the repulsive force and torque. This can be done in a way similar to the previous step, i.e., by dissecting the perimeter of particle j into m×n patches and checking which node lies most inside the second particle (particle k). However, in 3D, the following approximation works as well and can save a lot of CPU time.

Since the time step in a particulate fluid flow code is usually very small (so small that any particle only moves a distance smaller than a fraction of the particle size), the contact point on the second particle (particle k) as calculated above is usually extremely close to the surface of the first particle (particle j). Since the surface of the first particle can be represented using the parameter format of equation (84), where θ, φ are two parameters, try to solve for the corresponding parameters for the contact point in the local coordinate of particle j from equations (85). In these equations, ∈ is an additional parameter to be decided. Since the contact point is very close to the surface of the ellipsoid, ∈ is very close to 1. Dividing the first equation of equations (85) by ∈aⱼ, the second by ∈bⱼ, the third by ∈cⱼ, and summing up the square of each equation, yields equations (86) and (87). With ∈ and the third of equations (85), one can get equation (88). From the first of equations (85), one gets, if cos φ≠0, equation (89). If cos φ=0, one can obtain θ from the second of equations (85). After parameters ∈, θ, φ are calculated, the contact point on the first ellipsoid (particle j) can be approximated by equation (90). The inward normal at the contact point on the first particle is given by equation (91), if referred to the local coordinate system of particle j, and is given by equation (92).

In step 24, the repulsive force and torque on the second particle (particle k) and the first particle (particle j) are calculated by equations (93) and (94), where A is a force amplitude which should be large enough to keep the particles apart. In this work, it has been found that A should be one order larger than the resultant body force on particles j and k.

All particle pairs should be evaluated to determine all collisions. If it is determined in step 25 that all particle pairs have not yet been considered, the routine returns to step 21 to begin again for another particle pair. After all the possible collisions have been considered, and all the repulsive forces and torques are calculated, steps 26 and 27 are carried out as described in connection with the 2D scheme above.

### IV. External Bounding Box for Ellipsoidal Particles

As used herein, the phrase “external bounding box” refers to the smallest 3D rectangular box that just encloses the considered ellipsoidal particle and whose side faces are perpendicular to the x, y, z axes, respectively. Finding the external bounding box can greatly reduce the CPU time needed for calculating the linear and angular momenta and facilitate the code implementation to find the bounding force by domain wall. To find the external bounding box for an arbitrary ellipse in a 2D domain is relatively easy. However, to find the 3D external bounding box for an ellipsoidal particle of arbitrary orientation is more complicated.

To find such a box, first consider the parametric representation of a point on the surface of an ellipsoid (particle #j) with three axes a, b, c. This is given by equation (95). For simplicity of explanation, assume a≧b=c. However, the algorithm described below can be easily extended to the general case a≧b≧c. The orientation of the ellipsoid is defined by the direction cosines between its three axes and the fixed global axes, as per equation (96), where e_{α}^{j} is the unit base vector along the α-th major axis of the local coordinate system on the ellipsoidal particle j and e_{β} is the unit base vector along the β-th axis of the fixed global coordinate system. Two tangent vectors at the point can be easily obtained by taking the derivative of the parametric representation with respect to the two parameters, as given by equations (97). With respect to the fixed global coordinate system, the two tangent vectors are given by equations (98).

To find the two x side faces of the bounding box, i.e., the two side faces that are perpendicular to the fixed global x axis, find the parameters θ and φ at which both the two tangent vectors are perpendicular to the x axis. This is to say, find the parameters so that the x component of the two tangent vectors vanish using equations (99). From the second of equations (99), one obtains, if l₁₁ⁱ≠0, equation (100), from which two θ's can be obtained, using equations (101). Substituting the two θ's into the first of equations (99), yields equations (102).

Now two sets of parameters have been found for the two side faces perpendicular to the x axis. The next step is to calculate the two points with the smallest and largest x coordinates, according to equations (103). Hence, the corresponding x coordinates of the two side faces are given by equations (104). Moreover, the corresponding number of x cell numbers that the two side faces pass are given by equations (105), where int is a standard Fortran command taking the maximum integer that is smaller than the parameter or the result of operation defined in the parentheses.

If l₁₁ⁱ=0, it means that the long axis a is perpendicular to the fixed global x axis. So, the x coordinates of the two side faces perpendicular to the x axis are given by equations (106).

One can obtain the coordinates of the y and z side faces in a similar way. For y side faces, if l₁₂ⁱ≠0, the two sets of θ and φ are given by equations (107) and (108). The y coordinates of the y side faces are as stated in equations (109). Moreover, the corresponding cell numbers in the y direction where the two side faces pass through are given by equations (110). If l₁₂ⁱ=0, it means that the long axis a is perpendicular to the fixed global y axis. So, the y coordinates of the two side faces perpendicular to the y axis are given by equations (111).

For z side faces, if l₁₃ⁱ≠0, the two sets of θ and φ are given by equations (112) and (113). The z coordinates of the z side faces are as stated in equations (114). Moreover, the corresponding cell numbers in the z direction where the two side faces pass through are given by equations (115). If l₁₃ⁱ=0, it means that the long axis a is perpendicular to the fixed global z axis. So, the z coordinates of the two side faces perpendicular to the z axis are given by equations (116).

### V. Check Whether a Particle Touches the Solution Domain Wall

For a particulate fluid flow system, the particles may collide against each other as well as hit the solution domain boundary. If the domain boundary is a solid wall, one has to be able to detect the particles that hit the wall and implement suitable force and torque to prevent the hitting particles from penetrating the solid wall.

1. 2D Elliptic Particle

Suppose the major axis of the elliptic particle is oriented by an angle θ to the global axis. The coordinates of an arbitrary point on the boundary of the elliptic particle with respect to the local coordinate system are given by equations (117), where θ is a parameter. The tangent vector at the point can be obtained by taking the derivative of the coordinates with respect to the parameter defined by equation (118). It is noted that the above tangent vector is with respect to the local coordinate system which is oriented with an angle θ to the global coordinate system. In the global coordinate system, the tangent vector is defined by equation (119). If the particle is touching the vertical boundary of the solution domain, the tangent vector at the contact point should be parallel to the global y axis. Hence, the contact point may be obtained by equating the x component of τ (the vector defined in equation (119)) to be zero, according to equation (120) or equations (121). Therefore, the two possible contact points with the vertical wall are as stated in equations (122). The next step is to check whether the x coordinate of the two candidates fall inside the solution domain. Suppose the solution domain extends from x=0 to x=xlength. If tol<x₁, x₂<xlength−tol, where tol is a small positive real number or a tolerance, the particle is deemed to not be contacting the vertical domain wall. Although tol can be any small real number, tol is preferably within the range defined by equation (123), where 0.25<α<0.05. If min(x₁,x₂)<tol or max(x₁,x₂)>xlength−tol, the particle is considered to be touching the wall, and hence it necessary to construct a force and a torque so that the particle will not continue to penetrate the wall. To facilitate explanation of how the wall force and torque is constructed, it is more convenient to rearrange the notation. Let x₁=(x₁, y₁) be one of the candidates that has the smaller x coordinate, while x₂=(x₂,y₂) be the one that has the larger x coordinate. If x₁<tol, the particle is touching the left vertical wall. Construct a horizontal wall force and torque according to equations (124), where A is an arbitrary coefficient, the same as the one introduced for the collision scheme. Similarly, if x₁>xlength−tol, the particle is touching the right vertical wall. For this, construct a horizontal wall force and torque according to equations (125).

In a similar way, one can check whether the particle is touching the horizontal boundaries of the solution domain, and, if so, construct the wall force and torque.

2. 3D Ellipsoidal Particle

Checking whether an ellipsoidal particle is touching the solution domain boundary is more complicated. However, the external bounding box that was derived in the previous section can be easily applied for the purpose.

For example, in the x direction, the two points of an ellipsoid that are in contact with the x side faces of its bounding box are given in equation (103). As in the 2D case of elliptic particles, rearrange the notation such that x₁=(x₁, yₗ, z₁) denotes the one of the two points that has the smaller x coordinate, while x₂=(x₂, y₂, z₂) denotes the one with bigger x coordinate. The ellipsoid is touching the left boundary of the solution domain (suppose the left boundary is x=0) if equation (126) holds. If the left boundary is a wall, a bounding force and torque needs to be applied to keep the particle in the solution domain. The bounding force and torque are given by equations (127), where the tolerance tol can be set similar to the 2D case according to equation (128), while the parameter A can be one order larger than the resultant body force on the particle. Similarly, the ellipsoid is touching the right boundary of the solution domain (suppose the right boundary is x=xlength) if equation (129) holds. If the right boundary is a wall, a bounding force and torque needs to be applied to keep the particle in the solution domain. The bounding force and torque are given by equations (130).

### VI. Moment of Inertia of an Ellipsoid

Moment of inertia tensor of an ellipsoid is defined by equation (131), or in terms of tensor notation, equation (132), where rᵢ is the vector from the centroid of the particle to a material point in the particle. For an ellipsoidal particle, it would be more convenient to calculate the integral in a local coordinate system whose axes are the three major axes. Hence, the coordinate transformation is employed and the moment of inertia is rewritten as stated in equation (133), where l_{k′k} is the direction cosine for the k′^{th} coordinate axis of the local system and the k^{th} coordinate axis of the global system. Since both the local and global coordinate systems are orthonormal systems, one has equation (134). Applying the equality to the moment of inertia, the expression can be simplified to equation (135). The moment of inertia can be further simplified considering the symmetry of an ellipsoid as per equation (136). Hence, if i=j, the moment of inertia becomes (no sum on i) as given by equation (137). Furthermore, if i≠j, the moment of inertia becomes (no sum on i, j) as given by equation (138). Since rigid particles do not change shape in the simulation (they only change positions and orientations), it would be convenient to calculate the three integrals for each particle (with respect to the local coordinate system) before the time loop of the code, as per equation (139). With the above definition of the three integrals, one has, for i=j, equation (140), and for i≠j, (no sum on i, j), equation (141). It is preferable that the moment of inertia tensor be calculated at the end of each time step using equations (140) and (141).

### VII. Systems for Implementation

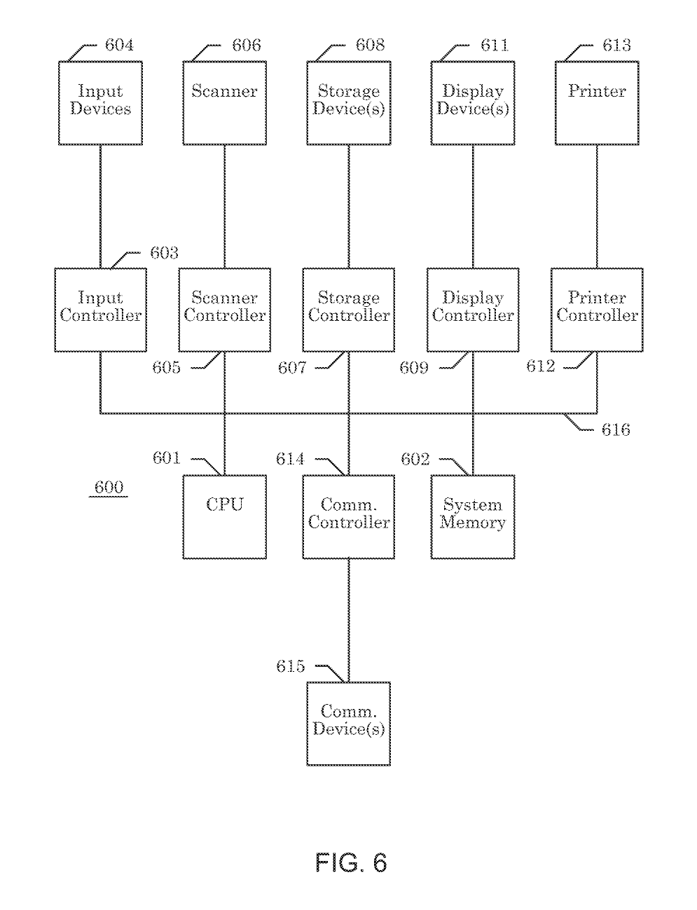

Having described the details of various embodiments and aspects of the invention, an exemplary system 600, which may be used to implement one or more such embodiments or aspects, will now be described with reference to FIG. 6. As illustrated in FIG. X, the system includes a central processing unit (CPU) X01 that provides computing resources and controls the system. CPU X01 may be implemented with a microprocessor or the like, and may also include a graphics processor and/or a floating point coprocessor for mathematical computations. System X00 may also include system memory X02, which may be in the form of random-access memory (RAM) and read-only memory (ROM).

A number of controllers and peripheral devices may also be provided, as shown in FIG. 6. An input controller 603 represents an interface to various input device(s) 604, such as a keyboard, mouse, or stylus. There may also be a scanner controller 605, which communicates with a scanner 606. System 600 may also include a storage controller 607 for interfacing with one or more storage devices 608 each of which includes a storage medium such as magnetic tape or disk, or an optical medium that might be used to record programs of instructions for operating systems, utilities and applications which may include embodiments of programs that implement various aspects of the present invention. Storage device(s) 608 may also be used to store processed data or data to be processed in accordance with the invention. System 600 may also include a display controller 609 for providing an interface to a display device 611, which may be any known type of display. System 600 may also include a printer controller 612 for communicating with a printer 613. A communications controller 614 may interface with one or more communication devices 615, which enables system 600 to connect to remote devices through any of a variety of networks including the Internet, a local area network (LAN), a wide area network (WAN), or through any suitable wireless protocol.

In the illustrated system, all major system components may connect to a bus 616, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including magnetic tape or disk or optical disc, or a transmitter-receiver pair.

The present invention may be conveniently implemented with software. However, alternative implementations are certainly possible, including a hardware implementation or a software/hardware implementation. Any hardware-implemented functions may be realized using ASIC(s), digital signal processing circuitry, or the like. Accordingly, the term “medium” as used herein includes any such medium having instructions implemented in software or hardware, or a combination thereof, embodied thereon. With these implementation alternatives in mind, it is to be understood that the figures and accompanying description provide the functional information one skilled in the art would require to write program code (i.e., software) or to fabricate circuits (i.e., hardware) to perform the processing required.

In accordance with further aspects of the invention, any of the above-described methods or steps thereof may be embodied in a program of instructions (e.g., software), which may be stored on, or conveyed to, a computer or other processor-controlled device for execution on a computer-readable medium. Alternatively, any of the methods or steps thereof may be implemented using functionally equivalent hardware (e.g., application specific integrated circuit (ASIC), digital signal processing circuitry, etc.) or a combination of software and hardware.

While the invention has been described in conjunction with several specific embodiments, further alternatives, modifications, and variations will be apparent to those skilled in the art in light of the foregoing description. Thus, the invention described herein is intended to embrace all such alternatives, modifications, and variations as may fall within the spirit and scope of the appended claims.

### APPENDIX

$$\begin{matrix}- {ε}_{0} ∇ \cdot ( ε ∇ φ ) - q , in Ω & ( 1 ) \\ ρ [ \frac{\partial u}{\partial t} + ( u \cdot ∇ ) u ] = - ∇ p + μ {∇}^{2} u + qE , in Ω , & ( 2 ) \\ ∇ \cdot u = 0 , in Ω , & ( 3 ) \\ \frac{1}{2} [ ∇ u + {( ∇ u )}^{T} ] = 0 , in P ( t ) . & ( 4 ) \\ \begin{matrix}\begin{matrix}ρ = \{ \begin{matrix}{ρ}_{s} & in P ( t ) \\ {ρ}_{f} & in Ω \backslash P ( t ) ,\end{matrix} \\ ε = \{ \begin{matrix}{ε}_{s} & in P ( t ) \\ {ε}_{f} & in Ω \backslash P ( t ) ,\end{matrix}\end{matrix} \\ q = \{ \begin{matrix}{q}_{s} & in P ( t ) \\ {q}_{f} & in Ω \backslash P ( t ) .\end{matrix}\end{matrix} & ( 5 ) \\ u = {u}^{BC} & ( 6 ) \\ p = {p}^{BC} , \frac{\partial u}{\partial n} = 0 , & ( 7 ) \\ φ = {V}^{BC} & ( 8 ) \\ \frac{\partial φ}{\partial n} = 0 , & ( 9 ) \\ \begin{matrix}x = {Lx}^{′} , y = {Ly}^{′} , z = {Lz}^{′} , t = \frac{L}{U} {t}^{′} , \\ p = ( {ρ}_{f} {U}^{2} ) {p}^{′} , u = {Uu}^{′} , ρ = {ρ}_{f} {ρ}^{′} , φ = {V}_{0} {φ}^{′} ,\end{matrix} & ( 10 ) \\ ∇ \cdot ( ε ∇ φ ) = - σ , & ( 11 ) \\ \frac{\partial u}{\partial t} + ( u \cdot ∇ ) u = - \frac{1}{ρ} ∇ p + \frac{1}{ρ Re} {∇}^{2} u + \frac{1}{ρ} {f}_{e} , & ( 12 ) \\ ∇ \cdot u = 0 , & ( 13 ) \\ \frac{1}{2} [ ∇ u + {( ∇ u )}^{T} ] = 0 , & ( 14 ) \\ \begin{matrix}ρ = \{ \begin{matrix}{ρ}_{s} / {ρ}_{f} & in P ( t ) \\ 1 & in Ω \backslash P ( t ) ,\end{matrix} Re = \frac{{ρ}_{f} UL}{μ} , \\ σ = \frac{{L}^{2}}{{ε}_{0} {V}_{0}} q , {f}_{e} = \frac{L}{{ρ}_{f} {U}^{2}} qE .\end{matrix} & ( 15 ) \\ \begin{matrix}x = {Lx}^{′} , y = {Ly}^{′} , z = {Lz}^{′} , t = \frac{{ρ}_{f} {L}^{2}}{μ} {t}^{′} , \\ p = \frac{μ U}{L} {p}^{′} , u = {Uu}^{′} , ρ = {ρ}_{f} {ρ}^{′} , φ = {V}_{0} {φ}^{′} ,\end{matrix} & ( 16 ) \\ ∇ \cdot ( ε ∇ φ ) = - σ , & ( 17 ) \\ \frac{\partial u}{\partial t} + Re ( u \cdot ∇ ) u = - \frac{1}{ρ} ∇ p + \frac{1}{ρ} {∇}^{2} u + \frac{1}{ρ} {f}_{e} , & ( 18 ) \\ ∇ \cdot u = 0 , & ( 19 ) \\ \frac{1}{2} [ ∇ u + {( ∇ u )}^{T} ] = 0 , & ( 20 ) \\ \begin{matrix}ρ = \{ \begin{matrix}{ρ}_{s} / {ρ}_{f} & in P ( t ) \\ 1 & in Ω \backslash P ( t ) ,\end{matrix} Re = \frac{{ρ}_{f} UL}{μ} , \\ σ = \frac{{L}^{2}}{{ε}_{0} {V}_{0} q} , {f}_{e} = \frac{{L}^{2}}{μ U} qE .\end{matrix} & ( 21 ) \\ {u}^{n} = u ( t = n Δ t ) & ( 22 ) \\ {u}^{*} = {u}^{n} + Δ t \{ - {[ ( u \cdot ∇ ) u ]}^{n} + \frac{1}{{ρ}^{n} Re} {∇}^{2} {u}^{n} + \frac{{f}_{e}^{n}}{{ρ}^{n}} \} . & ( 23 ) \\ ∇ \cdot {u}^{*} = ∇ \cdot [ \frac{Δ t}{{ρ}^{n}} ∇ {p}^{n + 1} ] . & ( 24 ) \\ \hat{u} = {u}^{*} - \frac{Δ t}{{ρ}^{n}} ∇ {p}^{n + 1} . & ( 25 ) \\ {u}^{**} = {u}^{n} + Δ t \{ - {Re [ ( u \cdot ∇ ) u ]}^{n} - \frac{1}{{ρ}^{n}} ∇ {p}^{n} + \frac{1}{{ρ}^{n}} {∇}^{2} {u}^{**} + \frac{{f}_{e}^{n}}{{ρ}^{n}} \} . & ( 26 ) \\ {u}^{*} = {u}^{**} + \frac{Δ t}{{ρ}^{n}} ∇ {p}^{n} . & ( 27 ) \\ ∇ \cdot {u}^{*} = ∇ \cdot [ \frac{Δ t}{ρ ( {φ}^{n} )} ∇ {p}^{n + 1} ] . & ( 28 ) \\ \hat{u} = {u}^{*} - \frac{Δ t}{{p}^{n}} ∇ {p}^{n + 1} . & ( 29 ) \\ {MU}^{n + 1} = {\int }_{P ( t )} {ρ}_{s} \hat{u} d Ω , & ( 30 ) \\ {I}_{p} {Ω}^{n + 1} = {\int }_{P ( t )} ( x - {x}_{c}^{n} ) \times {ρ}_{s} \hat{u} d Ω , & ( 31 ) \\ {u}^{n + 1} ( x , y ) = \{ \begin{matrix}u ( x , y ) & if ( x , y ) ∈ Ω \backslash P ( t ) \\ {U}^{n + 1} + {Ω}^{n + 1} \times ( x - {x}_{c}^{n} ) & if ( x , y ) ∈ P ( t )\end{matrix} & ( 32 ) \\ {x}_{c}^{n + 1} = {x}_{c}^{n} + Δ {tU}^{n + 1} . & ( 33 ) \\ {l}_{{1}^{′} α} = {l}_{{1}^{′} α} + Δ t {\sum }_{β = 1}^{3} {\sum }_{γ = 1}^{3} {e}_{αβγ} {Ω}_{β} {l}_{{1}^{′} γ} , α = 1 , 2 , 3 , & ( 34 ) \\ {\dot{U}}^{C} = \frac{1}{M} ( {F}^{C} + {F}^{w} ) , {\dot{Ω}}^{C} = {( {I}_{p} )}^{- 1} ( {T}^{C} + {T}^{w} ) , & ( 35 ) \\ {x}_{c}^{n + 1} ← {x}_{c}^{n + 1} + \frac{{( Δ t )}^{2}}{2} {\dot{U}}^{C} , & ( 36 ) \\ {l}_{{i}^{′} α} = {l}_{{i}^{′} α} + \frac{{( Δ t )}^{2}}{2} {\sum }_{β = 1}^{3} {\sum }_{γ = 1}^{3} {e}_{αβγ} {\dot{Ω}}_{β}^{C} {l}_{{i}^{′} γ} , α = 1 , 2 , 3 , i = 1 , 2 , 3. & ( 37 ) \\ {F}^{n} = - {[ ( u \cdot ∇ ) u ]}^{n} - \frac{1}{{ρ}^{n}} ∇ {p}^{n} + \frac{1}{{ρ}^{n} Re} {∇}^{2} {u}^{n} + \frac{{f}_{e}^{n}}{{p}^{n}} . & ( 39 ) \\ Δ t < \frac{1}{2} {min}_{i , j} [ \frac{Δ x}{Re \vert u \vert} , \frac{Δ y}{Re \vert v \vert} , \frac{Δ z}{Re \vert w \vert} , \sqrt{\frac{2 h}{\vert {F}^{n} \vert}} ] , & ( 40 ) \\ {F}^{n} = - {Re [ ( u \cdot ∇ ) u ]}^{n} - \frac{1}{{ρ}^{n}} ∇ {p}^{n} + \frac{1}{{ρ}^{n}} {∇}^{2} {u}^{n} + \frac{{f}_{e}^{n}}{{ρ}^{n}} . & ( 41 ) \\ {[ ( {u}^{n} \cdot ∇ ) {u}^{n} ]}_{( i , j , k )} = max ( {u}_{i , j , k}^{n} , 0 ) \frac{{u}_{i , j , k}^{n} - {u}_{i - 1 , j , k}^{n}}{Δ x} + min ( {u}_{i , j , k}^{n} , 0 ) \frac{{u}_{i + 1 , j , k}^{n} - {u}_{i , j , k}}{Δ x} + max ( {v}_{i , j , k}^{n} , 0 ) \frac{{u}_{i , j , k}^{n} - {u}_{i , j - 1 , k}^{n}}{Δ y} + min ( {v}_{i , j , k}^{n} , 0 ) \frac{{u}_{i , j + 1 , k}^{n} - {u}_{i , j , k}^{n}}{Δ y} + max ( {w}_{i , j , k}^{n} , 0 ) \frac{{u}_{i , j , k}^{n} - {u}_{i , , j , k - 1}^{n}}{Δ z} + min ( {w}_{i , j , k}^{n} , 0 ) \frac{{u}_{i , j , k + 1}^{n} - {u}_{i , j , k}^{n}}{Δ z} . & ( 42 ) \\ {[ μ {∇}^{2} {u}^{n} ]}_{( i , j , k )} = {μ}_{i , j , k} [ \frac{{u}_{i + 1 , j , k}^{n} - 2 {u}_{i , j , k}^{n} + {u}_{i - 1 , j , k}^{n}}{Δ {x}^{2}} + \frac{{u}_{i , j , + 1 , k}^{n} - 2 {u}_{i , j , k}^{n} + {u}_{i , j , - 1 , k}^{n}}{Δ {y}^{2}} + \frac{{u}_{i , j , k + 1}^{n} - 2 {u}_{i , j , k}^{n} + {u}_{i , j , k - 1}^{n}}{Δ {z}^{2}} ] . & ( 43 ) \\ {[ ∇ \cdot ( ε ∇ {φ}^{n} ) ]}_{( i , j , k )} = [ \frac{{ε}_{i + 1 / 2 , j , k}^{n} ( {φ}_{i + 1 , j , k}^{n} - {φ}_{i , j , k}^{n} ) - {ε}_{i - 1 / 2 , j , k}^{n} ( {φ}_{i , j , k}^{n} - {φ}_{i - 1 , j , k}^{n} )}{Δ {x}^{2}} + \frac{{ε}_{i , j + 1 / 2 , k}^{n} ( {φ}_{i , j , + 1 , k}^{n} - {φ}_{i , j , k ,}^{n} ) - {ε}_{i , j - 1 / 2 , k}^{n} ( {φ}_{i , j , k}^{n} - {φ}_{i , j - 1 , k}^{n} )}{Δ {y}^{2}} + \frac{{ε}_{i , j , k + 1 / 2}^{n} ( {φ}_{i , j , k + 1}^{n} - {φ}_{i , j , k}^{n} ) - {ε}_{i , j , k - 1 / 2}^{n} ( {φ}_{i , j , k}^{n} - {φ}_{i , j , k - 1}^{n} )}{Δ {z}^{2}} ] , & ( 44 ) \\ \begin{matrix}{ε}_{i + 1 / 2 , j , k}^{n} = \frac{{ε}_{i + 1 , j , k}^{n} + {ε}_{i , j , k}^{n}}{2} , {ε}_{i , j , + 1 / 2 , k}^{n} = \frac{{ε}_{i , j , + 1 , k}^{n} + {ε}_{i , j , k}^{n}}{2} \\ {ε}_{i , j , k + 1 / 2}^{n} = \frac{{ε}_{i , j , k + 1}^{n} + {ε}_{i , j , k}^{n}}{2} .\end{matrix} & ( 45 ) \\ \begin{matrix}\begin{matrix}{( {E}_{x}^{n} )}_{( i , j , k )} = - {( \frac{\partial {φ}^{n}}{\partial x} )}_{( i , j , k )} = - ( \frac{{φ}_{i + 1 , j , k}^{n} - {φ}_{i - 1 , j , k}^{n}}{2 Δ x} ) , \\ {( {E}_{y}^{n} )}_{( i , j , k )} = - {( \frac{\partial {φ}^{n}}{\partial y} )}_{( i , j , k )} = - ( \frac{{φ}_{i , j + 1 , k}^{n} - {φ}_{i , j - 1 , k}^{n}}{2 Δy} ) ,\end{matrix} \\ {( {E}_{z}^{n} )}_{( i , j , k )} = - {( \frac{\partial {φ}^{n}}{\partial z} )}_{( i , j , k )} = - ( \frac{{φ}_{i , j , k + 1}^{n} - {φ}_{i , j , k - 1}^{n}}{2 Δz} ) .\end{matrix} & ( 46 ) \\ \frac{{x}^{2}}{{( {a}_{j} + {a}_{k} )}^{2}} + \frac{{y}^{2}}{{( {b}_{j} + {a}_{k} )}^{2}} = 1. & ( 47 ) \\ \begin{matrix}{x}_{c , k , j} = ( {x}_{c , k} - {x}_{c , j} ) cos {α}_{j} + ( {u}_{c , k} - {y}_{c , j} ) sin {α}_{j} , \\ {y}_{c , k , j} = - ( {x}_{c , k} - {x}_{c , j} ) sin {α}_{j} + ( {y}_{c , k} - {y}_{c , j} ) cos {α}_{j} .\end{matrix} & ( 48 ) \\ {D}_{k , j} = \frac{{x}_{c , k , j}^{2}}{{( {a}_{j} + {a}_{k} )}^{2}} + \frac{{y}_{c , k , j}^{2}}{{( {b}_{j} + {a}_{k} )}^{2}} - 1. & ( 49 ) \\ {x}_{k}^{i} = {a}_{k} cos ( 2 ( i - 1 ) π / m , {y}_{k}^{i} = {b}_{k} sin ( 2 ( i - 1 ) π / m ) . & ( 50 ) \\ \begin{matrix}{x}_{k , j}^{i} = {x}_{k}^{i} cos ( {α}_{k} - {α}_{j} ) + {y}_{k}^{i} sin ( {α}_{k} - {α}_{j} ) + {x}_{c , k , j} , \\ {y}_{k , j}^{i} = - {x}_{k}^{i} sin ( {α}_{k} - {α}_{j} ) + {y}_{k}^{i} cos ( {α}_{k} - {α}_{j} ) + {y}_{c , k , j} .\end{matrix} & ( 51 ) \\ {D}_{k , j}^{i} = \frac{{( {x}_{k , j}^{i} )}^{2}}{{( {a}_{j} )}^{2}} + \frac{{( {y}_{k , j}^{i} )}^{2}}{{( {b}_{j} )}^{2}} - 1. & ( 52 ) \\ {x}_{j}^{i} = {a}_{j} cos ( 2 ( i - 1 ) π / m ) , {y}_{j}^{i} = {b}_{j} sin ( 2 ( i - 1 ) π / m ) . & ( 53 ) \\ \begin{matrix}{x}_{j , k}^{i} = {x}_{j}^{i} cos ( {α}_{j} - {α}_{k} ) + {y}_{j}^{i} sin ( {α}_{j} - {α}_{k} ) + {x}_{c , j , k} , \\ {y}_{j , k}^{i} = - {x}_{j}^{i} sin ( {α}_{j} - {α}_{k} ) + {y}_{j}^{i} cos ( {α}_{j} - {α}_{k} ) + {y}_{c , j , k} ,\end{matrix} & ( 54 ) \\ \begin{matrix}{x}_{c , j , k} = ( {x}_{c , j} - {x}_{c , k} ) cos {α}_{k} + ( {y}_{c , j} - {y}_{c , k} ) sin {α}_{k} , \\ {y}_{c , j , k} = - ( {x}_{c , j} - {x}_{c , k} ) sin {α}_{k} + ( {y}_{c , j} - {y}_{c , k} ) cos {α}_{k} .\end{matrix} & ( 55 ) \\ {D}_{j , k}^{i} = \frac{{( {x}_{j , k}^{i} )}^{2}}{{( {a}_{k} )}^{2}} + \frac{{( {y}_{j , k}^{i} )}^{2}}{{( {b}_{k} )}^{2}} - 1. & ( 56 ) \\ \begin{matrix}{F}_{j}^{C} = A \frac{( {x}_{cont , k} - {x}_{cont , j} , {y}_{cont , k} - {x}_{cont , j} )}{\vert ( {x}_{cont , k} - {x}_{cont , j} , {y}_{cont , k} - {x}_{cont , j} ) \vert} , \\ {F}_{k}^{C} = - {F}_{j}^{C} ,\end{matrix} & ( 57 ) \\ \begin{matrix}{T}_{j}^{C} = ( {x}_{cont , j} - {x}_{c , j} , {y}_{cont , j} - {y}_{c , j} ) \times {F}_{j}^{C} , \\ {T}_{k}^{C} = ( {x}_{cont , k} - {x}_{c , k} , {y}_{cont , k} - {y}_{c , k} ) \times {F}_{k}^{C} ,\end{matrix} & ( 58 ) \\ {x}_{c , j}^{n + 1} = {x}_{c , j}^{n} + Δ {tU}_{j}^{n + 1} + \frac{{F}_{j}^{C}}{2 {M}_{j}} Δ {t}^{2} , & ( 59 ) \\ {α}_{j}^{n + 1} = {α}_{j}^{n} + Δ t {ω}_{j}^{n + 1} + \frac{{T}_{j}^{C} \cdot {e}_{z}}{2 {I}_{j}} Δ {t}^{2} , & ( 60 ) \\ {n}_{k}^{k} = \frac{( - {b}_{k} cos θ , - {a}_{k} sin θ )}{{a}_{k}^{2} {sin}^{2} θ + {b}_{k}^{2} {cos}^{2} θ} , θ = \frac{2 ( p - 1 ) π}{m} . & ( 61 ) \\ {n}_{k} = ( {( {n}_{k}^{k} )}_{1} cos {α}_{k} - {( {n}_{k}^{k} )}_{2} sin {α}_{k} , {( {n}_{k}^{k} )}_{1} sin {α}_{k} + {( {n}_{k}^{k} )}_{2} cos {α}_{k} ) . & ( 62 ) \\ ε {a}_{j} cos θ = {x}_{cont , k}^{j} , ε {b}_{j} sin θ = {y}_{cont , k}^{j} . & ( 63 ) \\ ε = \sqrt{{( \frac{{x}_{cont , k}^{j}}{{a}_{j}} )}^{2} + {( \frac{{y}_{cont , k}^{j}}{{b}_{j}} )}^{2}} , & ( 64 ) \\ {θ}_{c} = arcsin ( \frac{{y}_{cont , k}^{j}}{ε {b}_{j}} ) . & ( 65 ) \\ ( {x}_{cont , j}^{j} , {y}_{cont , j}^{j} ) = ( {a}_{j} cos {θ}_{c} , {b}_{j} sin {θ}_{c} ) . & ( 66 ) \\ ( {x}_{cont , j} , {y}_{cont , j} ) = ( {a}_{j} cos {θ}_{c} cos {α}_{j} - {b}_{j} sin {θ}_{c} sin {α}_{j} , {a}_{j} cos {θ}_{c} sin {α}_{j} + {b}_{j} sin {θ}_{c} cos {α}_{j} ) . & ( 67 ) \\ {F}_{k}^{C} = A {\vert {x}_{cont , j} - {x}_{cont , k} \vert}^{2} {n}_{k} , {F}_{j}^{C} = - {F}_{k}^{C} . & ( 68 ) \\ \begin{matrix}{T}_{j}^{C} = ( {x}_{cont , j} - {x}_{c , j} , {y}_{cont , j} - {y}_{c , j} ) \times {F}_{j}^{C} , \\ {T}_{k}^{C} = ( {x}_{cont , k} - {x}_{c , k} , {y}_{cont , k} - {y}_{c , k} ) \times {F}_{k}^{C} .\end{matrix} & ( 69 ) \\ {l}_{αβ}^{j} = {e}_{α}^{j} \cdot {e}_{β} , & ( 70 ) \\ \frac{{x}^{2}}{{( {a}_{j} + {a}_{k} )}^{2}} + \frac{{y}^{2}}{{( {b}_{j} + {a}_{k} )}^{2}} + \frac{{z}^{2}}{{( {c}_{j} + {a}_{k} )}^{2}} = 1. & ( 71 ) \\ \begin{matrix}\begin{matrix}{x}_{c , k , j} = ( {x}_{c , k} - {x}_{c , j} ) {l}_{11}^{j} + ( {y}_{c , k} - {y}_{c , j} ) {l}_{12}^{j} + ( {z}_{c , k} - {z}_{c , j} ) {l}_{13}^{j} , \\ {y}_{c , k , j} = ( {x}_{c , k} - {x}_{c , j} ) {l}_{21}^{j} + ( {y}_{c , k} - {y}_{c , j} ) {l}_{22}^{j} + ( {z}_{c , k} - {z}_{c , j} ) {l}_{23}^{j} ,\end{matrix} \\ {z}_{c , k , j} = ( {x}_{c , k} - {x}_{c , j} ) {l}_{31}^{j} + ( {y}_{c , k} - {y}_{c , j} ) {l}_{32}^{j} + ( {z}_{c , k} - {z}_{c , j} ) {l}_{33}^{j} .\end{matrix} & ( 72 ) \\ {D}_{k , j} = \frac{{x}_{c , k , j}^{2}}{{( {a}_{j} + {a}_{k} )}^{2}} + \frac{{y}_{c , k , j}^{2}}{{( {b}_{j} + {a}_{k} )}^{2}} + \frac{{z}_{c , k , j}^{2}}{{( {c}_{j} + {a}_{k} )}^{2}} - 1. & ( 73 ) \\ {x}_{k} = {a}_{k} cos ( {θ}_{p} ) cos ( {φ}_{q} ) , {y}_{k} = {b}_{k} sin ( {θ}_{p} ) cos ( {φ}_{q} ) , {z}_{k} = {c}_{k} sin ( {φ}_{q} ) , & ( 74 ) \\ {θ}_{p} = \frac{2 p π}{m} , {φ}_{q} = - \frac{π}{2} + \frac{q π}{n} . & ( 75 ) \\ \begin{matrix}\begin{matrix}{x}_{k , j} = {x}_{k} {l}_{11}^{jk} + {y}_{k} {l}_{12}^{jk} + {z}_{k} {l}_{13}^{jk} + {x}_{c , k , j} , \\ {y}_{k , j} = {x}_{k} {l}_{21}^{jk} + {y}_{k} {l}_{22}^{jk} + {z}_{k} {l}_{23}^{jk} + {y}_{c , k , j} ,\end{matrix} \\ {z}_{k , j} = {x}_{k} {l}_{31}^{jk} + {y}_{k} {l}_{32}^{jk} + {z}_{k} {l}_{33}^{jk} + {z}_{c , k , j} ,\end{matrix} & ( 76 ) \\ {l}_{αβ}^{jk} = {\sum }_{γ = 1}^{3} {l}_{αγ}^{j} {l}_{βγ}^{k} . & ( 77 ) \\ {D}_{k , j} = \frac{{( {x}_{k , j} )}^{2}}{{( {a}_{j} )}^{2}} + \frac{{( {y}_{k , j} )}^{2}}{{( {b}_{j} )}^{2}} + \frac{{( {z}_{k , j} )}^{2}}{{( {c}_{j} )}^{2}} - 1. & ( 78 ) \\ \begin{matrix}\begin{matrix}{x}_{cont , k} = {x}_{cont , k}^{k} {l}_{11}^{k} + {y}_{cont , k}^{k} {l}_{21}^{k} + {z}_{cont , k}^{k} {l}_{31}^{k} + {x}_{c , k} , \\ {y}_{cont , k} = {x}_{cont , k}^{k} {l}_{12}^{k} + {y}_{cont , k}^{k} {l}_{22}^{k} + {z}_{cont , k}^{k} {l}_{32}^{k} + {y}_{c , k} ,\end{matrix} \\ {z}_{cont , k} = {x}_{cont , k}^{k} {l}_{13}^{k} + {y}_{cont , k}^{k} {l}_{23}^{k} + {z}_{cont , k}^{k} {l}_{33}^{k} + {z}_{c , k}\end{matrix} & ( 79 ) \\ \begin{matrix}\begin{matrix}{x}_{cont , k}^{j} = {x}_{cont , k}^{k} {l}_{11}^{k} + {y}_{cont , k}^{k} {l}_{12}^{k} + {z}_{cont , k}^{k} {l}_{13}^{k} + {x}_{c , k , j} , \\ {y}_{cont , k}^{j} = {x}_{cont , k}^{k} {l}_{21}^{k} + {y}_{cont , k}^{k} {l}_{22}^{k} + {z}_{cont , k}^{k} {l}_{23}^{k} + {y}_{c , k , j} ,\end{matrix} \\ {z}_{cont , k}^{j} = {x}_{cont , k}^{k} {l}_{31}^{k} + {y}_{cont , k}^{k} {l}_{32}^{k} + {z}_{cont , k}^{k} {l}_{33}^{k} + {z}_{c , k , j} .\end{matrix} & ( 80 ) \\ {n}_{k}^{k} = ( - {a}_{k} cos {θ}_{p} sin {φ}_{q} , - {b}_{k} sin {θ}_{p} sin {φ}_{q} , {c}_{k} cos {φ}_{q} ) \times ( - {a}_{k} sin {θ}_{p} , {b}_{k} cos {θ}_{p} , 0 ) , & ( 81 ) \\ {n}_{k}^{k} ← \frac{{n}_{k}^{k}}{\vert {n}_{k}^{k} \vert} , & ( 82 ) \\ {( {n}_{k} )}_{α} = {\sum }_{γ = 1}^{3} {{l}_{γα}^{k} ( {n}_{k}^{k} )}_{γ} . & ( 83 ) \\ ( {x}_{j} , {y}_{j} , {z}_{j} ) = ( {a}_{j} cos θ cos φ , {b}_{j} sin θ cos φ , {c}_{j} sin φ ) , & ( 84 ) \\ \begin{matrix}\begin{matrix}ε {a}_{j} cos θ cos φ = {x}_{cont , k}^{j} , \\ ε {b}_{j} sin θ cos φ = {y}_{cont , k}^{j} ,\end{matrix} \\ ε {c}_{j} sin φ = {z}_{cont , k}^{j} .\end{matrix} & ( 85 ) \\ 1 = {( \frac{{x}_{cont , k}^{j}}{ε {a}_{j}} )}^{2} + {( \frac{{y}_{cont , k}^{j}}{ε {b}_{j}} )}^{2} + {( \frac{{z}_{cont , k}^{j}}{ε {c}_{j}} )}^{2} & ( 86 ) \\ ε = \sqrt{{( \frac{{x}_{cont , k}^{j}}{{a}_{j}} )}^{2} + {( \frac{{y}_{cont , k}^{2}}{{b}_{j}} )}^{2} + {( \frac{{z}_{cont , k}^{j}}{{c}_{j}} )}^{2}} . & ( 87 ) \\ φ = arcsin ( \frac{{z}_{cont , k}^{j}}{ε {c}_{j}} ) . & ( 88 ) \\ θ = arccos ( \frac{{x}_{cont , k}^{j}}{ε {a}_{j} cos φ} ) . & ( 89 ) \\ ( {x}_{cont , j}^{j} , {y}_{cont , j}^{j} , {z}_{cont , j}^{j} ) = ( {a}_{j} cos θ cos φ , {b}_{j} sin θcosφ , {c}_{j} sin φ ) . & ( 90 ) \\ {n}_{j}^{j} = ( - {a}_{j} cos θ sin φ , - {b}_{j} sin θsin φ , {c}_{j} cos φ ) \times ( - {a}_{k} sin θ , {b}_{j} cos θ , 0 ) , & ( 91 ) \\ {( {n}_{j} )}_{α} = {\sum }_{γ = 1}^{3} {{l}_{γα}^{j} ( {n}_{j}^{j} )}_{γ} . & ( 92 ) \\ {F}_{k}^{C} = {An}_{k} , {F}_{j}^{C} = - {F}_{k}^{C} , & ( 93 ) \\ \begin{matrix}{T}_{j}^{C} = ( {x}_{cont , j} - {x}_{c , j} , {y}_{cont , j} - {y}_{c , j} , {z}_{cont , j} - {z}_{c , j} ) \times {F}_{j}^{C} , \\ {T}_{k}^{C} = ( {x}_{cont , k} - {x}_{c , k} , {y}_{cont , k} - {y}_{c , k} , {z}_{cont , k} - {z}_{c , k} ) \times {F}_{k}^{C} ,\end{matrix} & ( 94 ) \\ ( x , y , z ) = ( a cos θ cos φ , b sin θ cos φ , c sin φ ) & ( 95 ) \\ {l}_{αβ}^{j} = {e}_{α}^{j} \cdot {e}_{β} , & ( 96 ) \\ \begin{matrix}{τ}_{1} = ( - a cos θ sin φ , - b sin θ sin φ , c cos φ ) , \\ {τ}_{2} = ( - a sin θ cos φ , b cos θ cos φ , 0 ) .\end{matrix} & ( 97 ) \\ {τ}_{1} = ( - {al}_{11}^{j} cos θ sin φ - {bl}_{21}^{j} sin θ sin φ + {cl}_{31}^{j} cos φ , - {al}_{12}^{j} cos θsinφ - {bl}_{22}^{j} sin θsin φ + {cl}_{32}^{j} cos φ , - {al}_{13}^{j } cos θ sin φ - {bl}_{23}^{j} sin θ sin φ + {cl}_{33}^{j} cos φ , & ( 98 ) \\ {τ}_{2} = ( - {al}_{11}^{j} sin θ cos φ + {bl}_{21}^{j} cos θ cos φ , - {al}_{12}^{j} sin θcos φ + {bl}_{22}^{j} cos θ cos φ , - {al}_{13}^{j} sin θ cos φ + {bl}_{23}^{j} cos θ cos φ ) . & \\ \begin{matrix}{al}_{11}^{j} cos θ sin φ + {bl}_{21}^{j} sin θ sin φ - {cl}_{31}^{j} cos φ = 0 , \\ {al}_{11}^{j} sin θ cos φ - {bl}_{21}^{j} cos θ cos φ = 0.\end{matrix} & ( 99 ) \\ tan θ = \frac{{bl}_{21}^{j}}{{al}_{11}^{j}} . & ( 100 ) \\ {θ}_{1} = arctan [ \frac{{bl}_{21}^{j}}{{al}_{11}^{j}} ] , {θ}_{2} = {θ}_{1} + π . & ( 101 ) \\ {φ}_{1} arctan [ \frac{{cl}_{31}^{j}}{{al}_{11}^{j} cos θ + {bl}_{21}^{j} sin θ} ] , {φ}_{2} = - {φ}_{1} . & ( 102 ) \\ ( {x}_{1} , {y}_{1} , {z}_{1} ) = ( {x}_{c}^{j} + {al}_{11}^{j} cos {θ}_{1} cos {φ}_{1} + {bl}_{21}^{j} sin {θ}_{1} cos {φ}_{1} + {cl}_{31}^{j} sin {φ}_{1} , {y}_{c}^{j} + {al}_{12}^{j} cos {θ}_{1} cos {φ}_{1} + {bl}_{22}^{j} sin {θ}_{1} cos {φ}_{1} + {cl}_{32}^{j} sin {φ}_{1} , {z}_{c}^{j} + {al}_{13}^{j} cos {θ}_{1} cos {φ}_{1} + {bl}_{23}^{j} sin {θ}_{1} cos {φ}_{1} + {cl}_{33}^{j} sin {φ}_{1} ) , & ( 103 ) \\ ( {x}_{2} , {y}_{2} , {z}_{2} ) = ( {x}_{c}^{j} + {al}_{11}^{j} cos {θ}_{2} cos {φ}_{2} + {bl}_{21}^{j} sin {θ}_{2} cos {φ}_{2} + {cl}_{31}^{j} sin {φ}_{2} , {y}_{c}^{j} + {al}_{12}^{j} cos {θ}_{1} cos {φ}_{1} + {bl}_{22}^{j} sin {θ}_{2} cos {φ}_{2} + {cl}_{32}^{j} sin {φ}_{2} , {z}_{c}^{j} + {al}_{13}^{j} cos {θ}_{1} cos {φ}_{1} + {bl}_{23}^{j} sin {θ}_{2} cos {φ}_{2} + {cl}_{33}^{j} sin {φ}_{2} ) . & \\ \begin{matrix}{x}_{1} = {x}_{c}^{j} + {al}_{11}^{j} cos {θ}_{1} cos {φ}_{1} + {bl}_{21}^{j} sin {θ}_{1} cos {φ}_{1} + {cl}_{31}^{j} sin {φ}_{1} , \\ {x}_{2} = {x}_{c}^{j} + {al}_{11}^{j} cos {θ}_{2} cos {φ}_{2} + {bl}_{21}^{j} sin {θ}_{2} cos {φ}_{2} + {cl}_{31}^{j} sin {φ}_{2} .\end{matrix} & ( 104 ) \\ {i}_{1} = int ( min ( {x}_{1} , {x}_{2} ) / Δ x ) + 1 , {i}_{2} = int ( max ( {x}_{1} , {x}_{2} ) / Δ x ) + 1 , & ( 105 ) \\ {x}_{1} = {x}_{c}^{j} - b , {x}_{2} = {x}_{c}^{j} + b . & ( 106 ) \\ {θ}_{1} = arctan [ \frac{{bl}_{22}^{j}}{{al}_{12}^{j}} ] , {θ}_{2} = {θ}_{1} + π . & ( 107 ) \\ {φ}_{1} = arctan [ \frac{{cl}_{32}^{j}}{{al}_{12}^{j} cos {θ}_{1} + {bl}_{22}^{j} sin {θ}_{1}} ] , {φ}_{2} = - {φ}_{1} . & ( 108 ) \\ \begin{matrix}{y}_{1} = {y}_{c}^{j} + {al}_{12}^{j} cos {θ}_{1} cos {φ}_{1} + {bl}_{22}^{j} sin {θ}_{1} cos {φ}_{1} + {cl}_{32}^{j} sin {φ}_{1} , \\ {y}_{2} = {y}_{c}^{j} + {al}_{12}^{j} cos {θ}_{2} cos {φ}_{2} + {bl}_{22}^{j} sin {θ}_{2} cos {φ}_{2} + {cl}_{32}^{j} sin {φ}_{2} .\end{matrix} & ( 109 ) \\ \begin{matrix}{j}_{1} = int ( min ( {y}_{1} , {y}_{2} ) / Δ y ) + 1 , \\ {j}_{2} = int ( max ( {y}_{1} , {y}_{2} ) / Δ y ) + 1.\end{matrix} & ( 110 ) \\ {y}_{1} = {y}_{c}^{j} - b , {y}_{2} = {y}_{c}^{j} + b . & ( 111 ) \\ {θ}_{1} = arctan [ \frac{{bl}_{23}^{j}}{{al}_{13}^{j}} ] , {θ}_{2} = {θ}_{1} + π . & ( 112 ) \\ {φ}_{1} = arctan [ \frac{{cl}_{33}^{j}}{{al}_{13}^{j} cos {θ}_{1} + {bl}_{23}^{j} sin {θ}_{1}} ] , {φ}_{2} = - {φ}_{1} . & ( 113 ) \\ {z}_{1} = {z}_{c}^{j} + {al}_{13}^{j} cos {θ}_{1} cos {φ}_{1} + {bl}_{23}^{j} sin {θ}_{1} cos {φ}_{1} + {cl}_{33}^{j} sin {φ}_{1} , & ( 114 ) \\ {z}_{2} = {z}_{c}^{j} + {al}_{13}^{j} cos {θ}_{2} cos {φ}_{2} + {bl}_{23}^{j} sin {θ}_{2} cos {φ}_{2} + {cl}_{33}^{j} sin {φ}_{2} . & \\ \begin{matrix}{k}_{1} - int ( min ( {z}_{1} , {z}_{2} ) / Δ z ) + 1 , \\ {k}_{2} = int ( max ( {z}_{1} , {z}_{2} ) / Δ z ) + 1.\end{matrix} & ( 115 ) \\ {z}_{1} = {z}_{c}^{j} - b , {z}_{2} = {z}_{c}^{j} + b . & ( 116 ) \\ {x}^{′} = a cos θ , {y}^{′} = b sin θ , & ( 117 ) \\ τ = \frac{d}{d θ} ( {x}^{′} , {y}^{′} ) = ( - a sin θ , b cos θ ) . & ( 118 ) \\ τ = ( - a sin θ cos φ - b cos θ sin φ , - a sin θ sin φ + b cos θ cos φ ) . & ( 119 ) \\ - a sin {θ}_{c} cos φ - b cos {θ}_{c} sin φ = 0 & ( 120 ) \\ {θ}_{c 1} = - arctan ( \frac{b}{a} tan φ ) , {θ}_{c 2} = {θ}_{c 1} + π . & ( 121 ) \\ {x}_{1} = ( {x}_{1} , {y}_{1} ) = {x}_{c} + ( a cos {θ}_{c 1} cos φ - b sin {θ}_{c 1} sin φ , a cos {θ}_{c 1} sin φ + b sin {θ}_{c 1} cos φ ) , & ( 122 ) \\ {x}_{2} = ( {x}_{2} , {y}_{2} ) = {x}_{c} ( a cos {θ}_{c 2} cos φ - b sin {θ}_{c 2} sin φ , a cos {θ}_{c 2} sin φ + b sin {θ}_{c 2} cos φ ) . & \\ tol = α ( Δ x + Δ y ) / 2 , & ( 123 ) \\ {F}^{w} = ( {A ( tol - {x}_{1} )}^{2} , 0 ) , {T}^{w} = ( {x}_{1} - {x}_{c} ) \times {F}^{w} , & ( 124 ) \\ \begin{matrix}{F}^{w} = ( - {A ( {x}_{2} + tol - xlength )}^{2} , 0 ) , \\ {T}^{w} = ( {x}_{2} - {x}_{c} ) \times {F}^{w} .\end{matrix} & ( 125 ) \\ {x}_{1} < tol . & ( 126 ) \\ {F}^{w} = ( {A ( tol - {x}_{1} )}^{2} , 0 , 0 ) , {T}^{w} = ( {x}_{1} - {x}_{c} ) \times {F}^{w} , & ( 127 ) \\ tol = α ( Δ x + Δ y + Δ z ) / 3 , 0.05 < α < 0.25 , & ( 128 ) \\ {x}_{2} > xlength - tol . & ( 129 ) \\ {F}^{w} = ( - {A ( tol - {x}_{2} )}^{2} , 0 , 0 ) , {T}^{w} = ( {x}_{2} - {x}_{c} ) \times {F}^{w} . & ( 130 ) \\ {I}_{P} = {\int }_{P} ρ ( r \cdot rI - r ⊗ r ) d Ω & ( 131 ) \\ {( {I}_{P} )}_{ij} = {\int }_{P} ρ ( {r}_{k} {r}_{k} {δ}_{ij} - {r}_{i} {r}_{j} ) d Ω , & ( 132 ) \\ {( {I}_{P} )}_{ij} = {\int }_{P} ρ ( {r}_{{k}^{′}} {r}_{{l}^{′}} {l}_{{k}^{′} k} {l}_{{l}^{′} k} {δ}_{ij} - {r}_{{k}^{′}} {r}_{{l}^{′}} {l}_{{k}^{′} i} {l}_{{l}^{′} j} ) d Ω , & ( 133 ) \\ {l}_{{k}^{′} k} {l}_{{l}^{′} k} = {δ}_{{k}^{′} {l}^{′}} . & ( 134 ) \\ \begin{matrix}{( {I}_{P} )}_{ij} = {\int }_{P} ρ ( {r}_{{k}^{′}} {r}_{{l}^{′}} {δ}_{{k}^{′} {l}^{′}} {δ}_{ij} - {r}_{{k}^{′}} {r}_{{l}^{′}} {l}_{{k}^{′} i} {l}_{{l}^{′} j} ) d Ω \\ = {\int }_{P} ρ ( {r}_{{k}^{′}} {r}_{{k}^{′}} {δ}_{ij} - {r}_{{k}^{′}} {r}_{{l}^{′}} {l}_{{k}^{′} i} {l}_{{l}^{′} j} ) d Ω .\end{matrix} & ( 135 ) \\ {\int }_{P} ρ {r}_{{k}^{′}} {r}_{{l}^{′}} d Ω = 0 if {k}^{′} \neq {l}^{′} . & ( 136 ) \\ {( {I}_{P} )}_{ii} = {\int }_{P} ρ [ 1 - {l}_{{1}^{′} i} {l}_{{1}^{′} i} ) {r}_{{1}^{′}} {r}_{{1}^{′}} + ( 1 - {l}_{{2}^{′} i} {l}_{{2}^{′} i} ) {r}_{{2}^{′}} {r}_{{2}^{′}} + ( 1 - {l}_{{3}^{′} i} {l}_{{3}^{′} i} ) {r}_{{3}^{′}} {r}_{{3}^{′}} ] d Ω & ( 137 ) \\ {( {I}_{P} )}_{ij} = - {\int }_{P} ρ [ {l}_{{1}^{′} i} {l}_{{1}^{′} j} {r}_{{1}^{′}} {r}_{{1}^{′}} + {l}_{{2}^{′} i} {l}_{{2}^{′} j} {r}_{{2}^{′}} {r}_{{2}^{′}} + {l}_{{3}^{′} i} {l}_{{3}^{′} j} {r}_{{3}^{′}} {r}_{{3}^{′}} ] d Ω & ( 138 ) \\ {I}_{{1}^{′}} = {\int }_{P} ρ {r}_{{1}^{′}} {r}_{{1}^{′}} d Ω , {I}_{{2}^{′}} = {\int }_{P} ρ {r}_{{2}^{′}} {r}_{{2}^{′}} d Ω , {I}_{{3}^{′}} = {\int }_{P} ρ {r}_{{3}^{′}} {r}_{{3}^{′}} d Ω . & ( 139 ) \\ {( {I}_{P} )}_{ii} = ( 1 - {l}_{{1}^{′} i} {l}_{{1}^{′} i} ) {I}_{{1}^{′}} + ( 1 - {l}_{{2}^{′} i} {l}_{{2}^{′} i} ) {I}_{{2}^{′}} + ( 1 - {l}_{{3}^{′} i} {l}_{{3}^{′} i} ) {I}_{{3}^{′}} & ( 140 ) \\ {( {I}_{P} )}_{ii} = - {l}_{{1}^{′} i} {l}_{{1}^{′} j} {I}_{{1}^{′}} - {l}_{{2}^{′} i} {l}_{{2}^{′} j} {I}_{{2}^{′}} - {l}_{{3}^{′} i} {l}_{{3}^{′} j} {I}_{{3}^{′}} . & ( 141 )\end{matrix}$$

What is claimed is:

1. A non-transitory medium encoded with a program for execution by one or more processors to determine particle information in a particulate fluid flow, the program comprising:
instructions for determining whether two particles can be in contact based on the location of the center of a second of the two particles with respect to an envelop of the first of the two particles;
instructions for determining more precisely whether the first and second particles are in contact, including instructions for:
dissecting the perimeter of the second particle into a plurality of patches defining a plurality of nodes and checking whether each node is located in the envelop, and which node is most inside the envelop,
determining the contact point on the second particle based on the results of executing the dissecting instructions, and
determining the contact point on the first particle;
instructions for calculating a force and torque on the particles from the fluid; and
instructions for determining, based at least in part on the calculated force and torque on the particles, updated velocity components, position, and orientation of at least one of the particles.

2. The non-transitory medium as recited in claim 1, wherein the instructions for determining the contact point on the first particle comprise instructions for representing the surface of the first particle by a multiple parameter equation and solving for the multiple parameters in a local coordinate system of the first particle.

3. A non-transitory medium encoded with a program for execution by one or more processors to determine particle information in a particulate fluid flow in a solution domain, the program comprising:
instructions for finding an external bounding box for a particle in the particulate fluid flow;
instructions for determining whether the particle is in contact with a boundary of the solution domain; and
instructions for constructing a wall force and torque on the particle using the external bounding box.

4. The non-transitory medium as recited in claim 3, wherein the boundary includes a vertical wall and a horizontal wall, and the instructions for determining comprise instructions for determining whether a particle is in contact with the vertical wall and instructions for determining whether the particle is in contact with the horizontal wall.

5. The non-transitory medium as recited in claim 3, wherein the particle is an ellipsoidal particle.

6. The non-transitory medium as recited in claim 5, wherein the program further comprises instructions for calculating the moment of inertia tensor for each particle in the particulate fluid flow.
